(19) United States
(12) Patent Application Publication
(10) Pub. No.: US 2026/0037365 A1
(43) Pub. Date: Feb. 5, 2026

(54) RISK AND ANOMALY DETECTION USING A LARGE LANGUAGE MODEL

(71) Applicant: OKTA, INC., SAN FRANCISCO, CA (US)

(72) Inventors: Jinlong FU, Oakville (CA); RaghuRam PAMIDIMARRI, Pleasanton, CA (US); Alex Kwan Tat MA, Daly City, CA (US); Thach Vincent LE, Scarborough (CA)

(21) Appl. No.: 18/791,157

(22) Filed: Jul. 31, 2024

(51) Int. Cl. G06F 11/07; G06F 11/34; G06F 21/57

(52) U.S. Cl. CPC G06F 11/0793; G06F 11/0766; G06F 11/3438; G06F 21/577

(57) ABSTRACT

Methods, systems, devices, and computer-readable media for risk and anomaly detection using one or more large language model (LLMs) are described. An identity management system may use an LLM to generate a predicted next system event or sequence of next system events associated with a user of the identity management system. A detected system event associated with the user may be compared to a predicted next system event of the sequence of predicted next system events. Based on a difference between the detected system event and the predicted next system event, a risk level associated with the detected system event may be determined. Based on determining that the risk level satisfies a threat threshold and based on policy information associated with the identity management system a remediation action may be performed.

### FIELD OF TECHNOLOGY

The present disclosure relates generally to identity management, and more specifically to risk and anomaly detection using one or more large language models (LLMs).

### BACKGROUND

An identity management system may be employed to manage and store various forms of user data, including usernames, passwords, email addresses, permissions, roles, group memberships, etc. The identity management system may provide authentication services for applications, devices, users, and the like. The identity management system may enable organizations to manage and control access to resources, for example, by serving as a central repository that integrates with various identity sources. Some identity management system may include automated features that defend against security attacks or that remediate security vulnerabilities. In some cases, it may be a challenge for such systems to identify new types of attacks or security threats or for customers to determine the reason a particular user or event was flagged as a security threat.

### SUMMARY

The described techniques relate to improved methods, systems, devices, and computer-readable media that support risk and anomaly detection using one or more large language models (LLMs). For example, the described techniques provide a framework for using generative artificial intelligence (AI) to predict customary user behaviors or system events, to detect events or activities that deviate from those customary behaviors, and to perform actions to remediate against anomalies.

A method of an identity management system is described. The method may include generating, using an LLM, a sequence of predicted next system events associated with a user of the identity management system, comparing, using the LLM, a detected system event associated with the user to a predicted next system event of the sequence of predicted next system events, determining, using the LLM and based on a difference between the detected system event and the predicted next system event, a risk level associated with the detected system event, and performing, based on policy information associated with the identity management system and on a determination that the risk level satisfies a threat threshold, a remediation action.

An identity management system is described. The apparatus may include one or more memories storing processor executable code, and one or more processors coupled with the one or more memories. The one or more processors may individually or collectively be operable to execute the code to cause the apparatus to generate, using an LLM, a sequence of predicted next system events associated with a user of the identity management system, compare, using the LLM, a detected system event associated with the user to a predicted next system event of the sequence of predicted next system events, determine, using the LLM and based on a difference between the detected system event and the predicted next system event, a risk level associated with the detected system event, and perform, based on policy information associated with the identity management system and on a determination that the risk level satisfies a threat threshold, a remediation action.

An identity management system is described. The apparatus may include means for generating, using an LLM, a sequence of predicted next system events associated with a user of the identity management system, means for comparing, using the LLM, a detected system event associated with the user to a predicted next system event of the sequence of predicted next system events, means for determining, using the LLM and based on a difference between the detected system event and the predicted next system event, a risk level associated with the detected system event, and means for performing, based on policy information associated with the identity management system and on a determination that the risk level satisfies a threat threshold, a remediation action.

A non-transitory computer-readable medium storing code is described. The code may include instructions executable by one or more processors of an identity management system to generate, using an LLM, a sequence of predicted next system events associated with a user of the identity management system, compare, using the LLM, a detected system event associated with the user to a predicted next system event of the sequence of predicted next system events, determine, using the LLM and based on a difference between the detected system event and the predicted next system event, a risk level associated with the detected system event, and perform, based on policy information associated with the identity management system and on a determination that the risk level satisfies a threat threshold, a remediation action.

### BRIEF DESCRIPTION OF THE DRAWINGS

FIG. 1 illustrates an example of a computing system that supports risk and anomaly detection using one or more large language models (LLMs) in accordance with aspects of the present disclosure.

FIG. 2 shows an example of a system architecture that supports risk and anomaly detection using one or more LLMs in accordance with aspects of the present disclosure.

FIGS. 3 to 6 show examples of user interfaces that support risk and anomaly detection using one or more LLMs in accordance with aspects of the present disclosure.

FIG. 7 shows a block diagram of an apparatus that supports risk and anomaly detection using one or more LLMs in accordance with aspects of the present disclosure.

FIG. 8 shows a block diagram of a controller that supports risk and anomaly detection using one or more LLMs in accordance with aspects of the present disclosure.

FIG. 9 shows a diagram of a system including a device that supports risk and anomaly detection using one or more LLMs in accordance with aspects of the present disclosure.

FIG. 10 shows a flowchart illustrating methods that support risk and anomaly detection using one or more LLMs in accordance with aspects of the present disclosure.

### DETAILED DESCRIPTION

Cloud computing provides for the delivery of computing services or resources over the Internet. Such services and resources may include software applications, data storage, databases, servers, virtual machines, operating systems, analytics, computing environments or platforms, authentication services, etc. Some organizations may use cloud computing to increase performance, manage computing and operating costs, provide for on-demand scalability of computing resources, improve reliability, and many other reasons. However, the use of cloud computing may present certain security vulnerabilities. As such, in order to ensure the security of an organization's cloud resources and, in some cases, the organization's on-premises resources as well, the organization may control access to the organization's resources (e.g., control what resources particular users are permitted to access, and what the users can do with the resources that they are permitted to access). For example, when a user of the organization (e.g., an employee of the organization) wishes to access the organization's resources, the user may be requested to log into an account associated with the organization. The user may provide user credentials, such as a combination of a username and a password or other information. The system may use the user credentials as authentication information to verify an identity of the user. Once authenticated, the system may determine whether the user has been granted permission or privileges to access the requested resources.

In some cases, the organization may employ a service provider, such as an identity management service provider, to provide identity and access management services on behalf of the organization. In such cases, the identity management service provider may provide the identity and access management service to the organization as well as to other organizations. The multiple organizations may be clients, customers, or tenants of the identity management service provider, and the identity management service provider may maintain an identity management system to manage the identities and access privileges of the users of the different organizations on behalf of those organizations. Some identity management system may include automated features that defend against security attacks or remediate security vulnerabilities. In some cases, it may be a challenge for such systems to identify new types of attacks or security threats or for customers to determine why a particular user or event was flagged as a security threat.

In accordance with aspects described herein, an identity management system may leverage system data, maintained by the identity management system for its various organizations, to train a machine learning model, such as a large language model (LLM), to detect system anomalies that may be indicative of a security threat or vulnerability. For instance, the identity management system may utilize an LLM to determine customary behaviors of one or more users of the identity management system and to use such information to predict a next expected activity or a sequence of next expected activities for each of the user. Based on detecting that an actual activity of the user differs from a predicted next expected activity, the identity management system may determine a level or risk associated with the detected activity or with the user. Based on determining that the level of risk satisfies a threshold, such as if the level of risk is determined to be high, the identity management system may perform a remediation action. The identity management system may further provide summarization details or automated responses to queries by an administrator of the organization as to the reason a particular activity was identified by the identity management system as a security threat.

The described techniques may enable the identity management system to effectively identify new types of attacks or security threats, thereby improving the security posture of the organizations. Further, such techniques may provide detailed insights to tenant administrators as to the reasons particular activities or users were flagged as security threats, thereby providing improved user experiences for the tenants.

Aspects of the disclosure are initially described in the context of an identity management system. Aspects of the disclosure are further illustrated by and described with reference to apparatus diagrams, system diagrams, user interfaces, and flowcharts that relate to risk and anomaly detection using one or more LLMs.

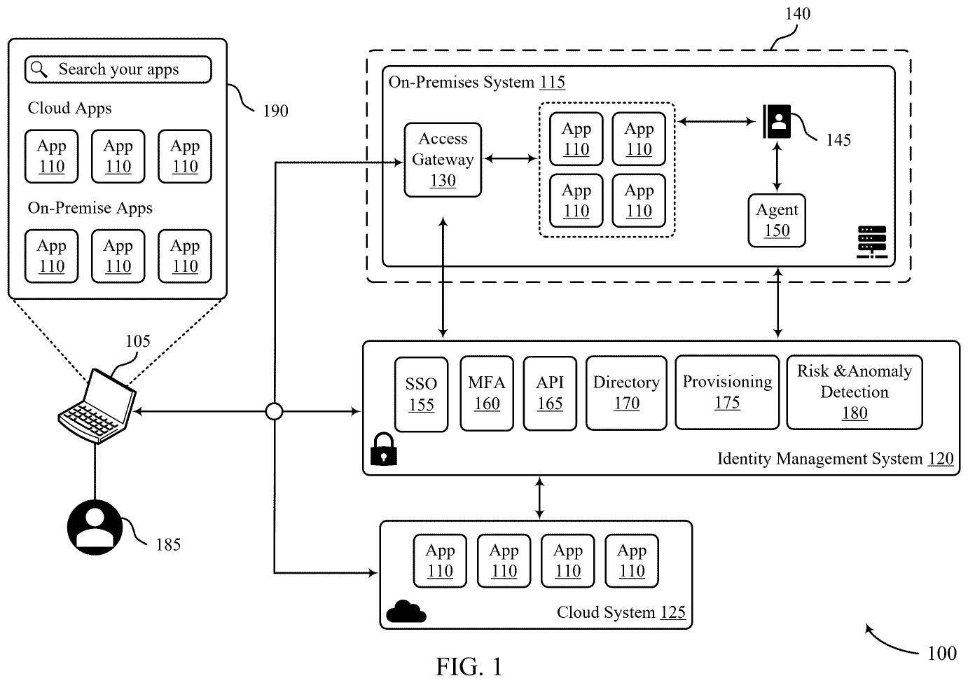

FIG. 1 illustrates an example of a computing system 100 that supports risk and anomaly detection using one or more LLMs in accordance with various aspects of the present disclosure. The computing system 100 includes a computing device 105 (such as a desktop, laptop, smartphone, tablet, or the like), an on-premises system 115, an identity management system 120, and a cloud system 125, which may communicate with each other via a network, such as a wired network (e.g., the Internet), a wireless network (e.g., a cellular network, a wireless local area network (WLAN)), or both. In some cases, the network may be implemented as a public network, a private network, a secured network, an unsecured network, or any combination thereof. The network may include various communication links, hubs, bridges, routers, switches, ports, or other physical and/or logical network components, which may be distributed across the computing system 100.

The on-premises system 115 (also referred to as an on-premises infrastructure or environment) may be an example of a computing system in which a client organization owns, operates, and maintains its own physical hardware and/or software resources within its own data center(s) and facilities, instead of using cloud-based (e.g., off-site) resources. Thus, in the on-premises system 115, hardware, servers, networking equipment, and other infrastructure components may be physically located within the “premises” of the client organization, which may be protected by a firewall 140 (e.g., a network security device or software application that is configured to monitor, filter, and control incoming/outgoing network traffic). In some examples, users may remotely access or otherwise utilize compute resources of the on-premises system 115, for example, via a virtual private network (VPN).

In contrast, the cloud system 125 (also referred to as a cloud-based infrastructure or environment) may be an example of a system of compute resources (such as servers, databases, virtual machines, containers, and the like) that are hosted and managed by a third-party cloud service provider using third-party data center(s), which can be physically co-located or distributed across multiple geographic regions. The cloud system 125 may offer high scalability and a wide range of managed services, including (but not limited to) database management, analytics, machine learning (ML), artificial intelligence (AI), etc. Examples of cloud systems 125 include (AMAZON WEB SERVICES) AWS®, MICROSOFT AZURE®, GOOGLE CLOUD PLATFORM®, ALIBABA CLOUD®, ORACLE® CLOUD INFRASTRUCTURE (OCI), and the like.

The identity management system 120 may support one or more services, such as a single sign-on (SSO) service 155, a multi-factor authentication (MFA) service 160, an application programming interface (API) service 165, a directory management service 170, a provisioning service 175 for various on-premises applications 110 (e.g., applications 110 running on compute resources of the on-premises system 115) and/or cloud applications 110 (e.g., applications 110 running on compute resources of the cloud system 125), or a risk and anomaly detection service 180, among other services. The SSO service 155, the MFA service 160, the API service 165, the directory management service 170, the provisioning service 175, or the risk and anomaly detection service 180 may be individually or collectively provided (e.g., hosted) by one or more physical machines, virtual machines, physical servers, virtual (e.g., cloud) servers, data centers, or other compute resources managed by or otherwise accessible to the identity management system 120.

A user 185 may interact with the computing device 105 to communicate with one or more of the on-premises system 115, the identity management system 120, or the cloud system 125. For example, the user 185 may access one or more applications 110 by interacting with an interface 190 of the computing device 105. In some implementations, the user 185 may be prompted to provide some form of identification (such as a password, personal identification number (PIN), biometric information, or the like) before the interface 190 is presented to the user 185. In some implementations, the user 185 may be a developer, customer, employee, vendor, partner, or contractor of a client organization (such as a group, business, enterprise, non-profit, or startup that uses one or more services of the identity management system 120). The applications 110 may include one or more on-premises applications 110 (hosted by the on-premises system 115), mobile applications 110 (configured for mobile devices), and/or one or more cloud applications 110 (hosted by the cloud system 125).

The SSO service 155 of the identity management system 120 may allow the user 185 to access multiple applications 110 with one or more credentials. Once authenticated, the user 185 may access one or more of the applications 110 (for example, via the interface 190 of the computing device 105). That is, based on the identity management system 120 authenticating the identity of the user 185, the user 185 may obtain access to multiple applications 110, for example, without having to re-enter the credentials (or enter other credentials). The SSO service 155 may leverage one or more authentication protocols, such as Security Assertion Markup Language (SAML) or OpenID Connect (OIDC), among other examples of authentication protocols. In some examples, the user 185 may attempt to access an application 110 via a browser. In such examples, the browser may be redirected to the SSO service 155 of the identity management system 120, which may serve as the identity provider (IdP). For example, in some implementations, the browser (e.g., the user's request communicated via the browser) may be redirected by an access gateway 130 (e.g., a reverse proxy-based virtual application configured to secure web applications 110 that may not natively support SAML or OIDC).

In some examples, the access gateway 130 may support integrations with legacy applications 110 using hypertext transfer protocol (HTTP) headers and Kerberos tokens, which may offer universal resource locator (URL)-based authorization, among other functionalities. In some examples, such as in response to the user's request, the IdP may prompt the user 185 for one or more credentials (such as a password, PIN, biometric information, or the like) and the user 185 may provide the requested authentication credentials to the IdP. In some implementations, the IdP may leverage the MFA service 160 for added security. The IdP may verify the user's identity by comparing the credentials provided by the user 185 to credentials associated with the user's account. For example, one or more credentials associated with the user's account may be registered with the IdP (e.g., previously registered, or otherwise authorized for authentication of the user's identity via the IdP). The IdP may generate a security token (such as a SAML token or Oath 2.0 token) containing information associated with the identity and/or authentication status of the user 185 based on successful authentication of the user's identity.

The IdP may send the security token to the computing device 105 (e.g., the browser or application 110 running on the computing device 105). In some examples, the application 110 may be associated with a service provider (SP), which may host or manage the application 110. In such examples, the computing device 105 may forward the token to the SP. Accordingly, the SP may verify the authenticity of the token and determine whether the user 185 is authorized to access the requested applications 110. In some examples, such as examples in which the SP determines that the user 185 is authorized to access the requested application, the SP may grant the user 185 access to the requested applications 110, for example, without prompting the user 185 to enter credentials (e.g., without prompting the user to log-in). The SSO service 155 may promote an improved user experience (e.g., by limiting the number of credentials the user 185 has to remember/enter), enhanced security (e.g., by leveraging secure authentication protocols and centralized security policies), and reduced credential fatigue, among other benefits.

The MFA service 160 of the identity management system 120 may enhance the security of the computing system 100 by prompting the user 185 to provide multiple authentication factors before granting the user 185 access to applications 110. These authentication factors may include one or more knowledge factors (e.g., something the user 185 knows, such as a password), one or more possession factors (e.g., something the user 185 is in possession of, such as a mobile app-generated code or a hardware token), or one or more inherence factors (e.g., something inherent to the user 185, such as a fingerprint or other biometric information). In some implementations, the MFA service 160 may be used in conjunction with the SSO service 155. For example, the user 185 may provide the requested login credentials to the identity management system 120 in accordance with an SSO flow and, in response, the identity management system 120 may prompt the user 185 to provide a second factor, such as a possession factor (e.g., a one-time passcode (OTP), a hardware token, a text message code, an email link/code). The user 185 may obtain access (e.g., be granted access by the identity management system 120) to the requested applications 110 based on successful verification of both the first authentication factor and the second authentication factor.

The API service 165 of the identity management system 120 can secure APIs by managing access tokens and API keys for various client organizations, which may enable (e.g., only enable) authorized applications (e.g., one or more of the applications 110) and authorized users (e.g., the user 185) to interact with a client organization's APIs. The API service 165 may enable client organizations to implement customizable login experiences that are consistent with their architecture, brand, and security configuration. The API service 165 may enable administrators to control user API access (e.g., whether the user 185 and/or one or more other users have access to one or more particular APIs). In some examples, the API service 165 may enable administrators to control API access for users via authorization policies, such as standards-based authorization policies that leverage OAuth 2.0. The API service 165 may additionally, or alternatively, implement role-based access control (RBAC) for applications 110. In some implementations, the API service 165 can be used to configure user lifecycle policies that automate API onboarding and off-boarding processes.

The directory management service 170 may enable the identity management system 120 to integrate with various identity sources of client organizations. In some implementations, the directory management service 170 may communicate with a directory service 145 of the on-premises system 115 via a software agent 150 installed on one or more computers, servers, and/or devices of the on-premises system 115. Additionally, or alternatively, the directory management service 170 may communicate with one or more other directory services, such as one or more cloud-based directory services. As described herein, a software agent 150 generally refers to a software program or component that operates on a system or device (such as a device of the on-premises system 115) to perform operations or collect data on behalf of another software application or system (such as the identity management system 120).

The provisioning service 175 of the identity management system 120 may support user provisioning and deprovisioning. For example, in response to an employee joining a client organization, the identity management system 120 may automatically create accounts for the employee and provide the employee with access to one or more resources via the accounts. Similarly, in response to the employee (or some other employee) leaving the client organization, the identity management system 120 may autonomously deprovision the employee's accounts and revoke the employee's access to the one or more resources (e.g., with little to no intervention from the client organization). The provisioning service 175 may maintain audit logs and records of user deprovisioning events, which may help the client organization demonstrate compliance and track user lifecycle changes. In some implementations, the provisioning service 175 may enable administrators to map user attributes and roles (e.g., permissions, privileges) between the identity management system 120 and connected applications 110, ensuring that user profiles are consistent across the identity management system 120, the on-premises system 115, and the cloud system 125.

The risk and anomaly detection service 180 of the identity management system 120 may support risk and anomaly detection associated with access to resources associated with a client organization. For instance, the risk and anomaly detection service 180 may utilize an LMM to determine customary behaviors of users of the client organization and to predict, based on such customary behaviors, a next expected activity or a sequence of next expected activities for each of the users. Based on detecting that an actual activity or system event of a user differs from a predicted next expected activity for that user a risk level associated with the detected activity or system event or with the user may be determined. Based on determining that the risk level satisfies a threshold, a remediation action may be performed. The risk and anomaly detection service 180 may further provide a tool or an interface that enables administrators of the client organizations to debug the detected activities or threats. For instance, the tool or interface may be used to provide summarization details or automated responses, such as via a chat bot, to queries by the administrator as to the reason a particular activity or event was identified as a security threat. In some cases, the risk and anomaly detection service 180 may recommend further remedial action that may be taken by the client organization to mitigate risk.

Although not depicted in the example of FIG. 1, a person skilled in the art would appreciate that the identity management system 120 may support or otherwise provide access to any number of additional or alternative services, applications 110, platforms, providers, or the like. In other words, the functionality of the identity management system 120 is not limited to the exemplary components and services mentioned in the preceding description of the computing system 100. The description herein is provided to enable a person skilled in the art to make or use the present disclosure. Various modifications to the present disclosure will be readily apparent to those skilled in the art, and the generic principles defined herein may be applied to other variations without departing from the scope of the present disclosure. Accordingly, the present disclosure is not limited to the examples and designs described herein, but is to be accorded the broadest scope consistent with the principles and novel features disclosed herein.

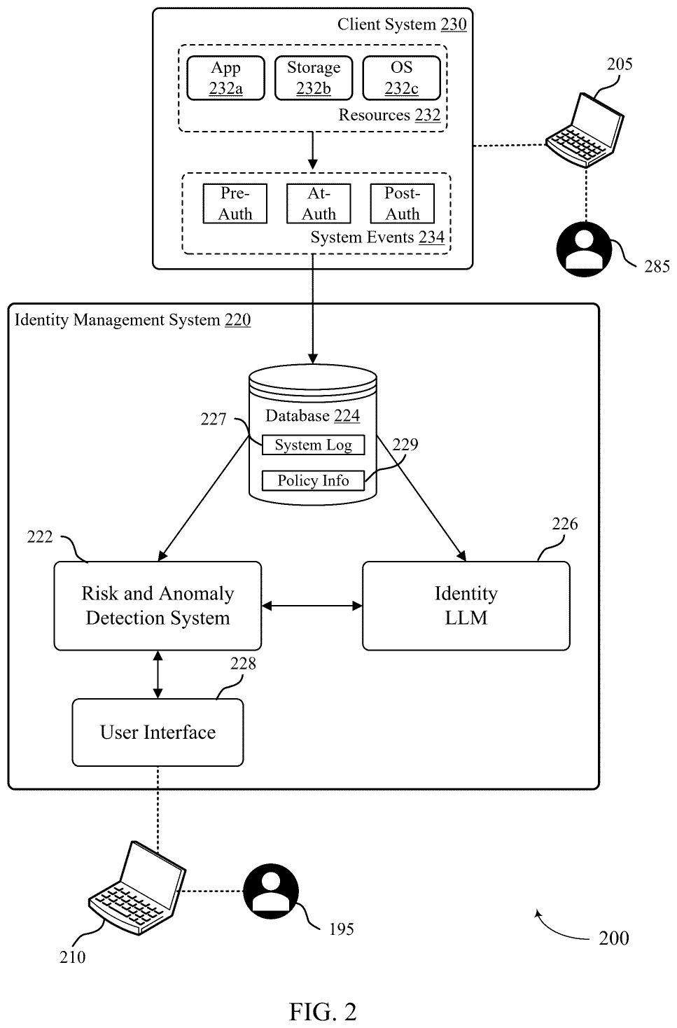

FIG. 2 shows an example of a system architecture 200 that supports risk and anomaly detection using one or more LLMs in accordance with aspects of the present disclosure. The system architecture 200 may include an administrator device 210, an identity management system 220, a client system 230, and client device 205. The identity management system 220 may be an example of identity management system 120 described with reference to FIG. 1.

The client system 230 may be a system of a client organization associated with the identity management system 220. In some implementations, multiple client systems, each associated with different client organizations, may be associated with the identity management system 220. The client system 230 may be or include the on-premises system 115 or the cloud system 125 described with reference to FIG. 1. The client system 230 may maintain, implement, or manage various resources 232, such as a software application 232a, data storage 232b, an operating system 232c, and other resources such as described with reference to FIG. 1. A user 285 (which may be an example of the user 185 of FIG. 1) may interact with a client device 205 (which may be an example of the computing device 105) to communicate with the client system 230. The user 285 may interact with the client system 230 to access one or more of the resources 232. In some cases, accessing or attempting to access one of the resources 232 may trigger one or more system events 234. For instance, in some cases the system events 234, may be a pre-authorization system event, an at-authorization system event, or a post-authorization system event. Each of the system events 234 may be logged in a system log 227 stored in a database 224 associated with the client system 230 and/or the identity management system 220.

The identity management system 220 may include a risk and anomaly detection system 222, the database 224, an identity LLM 226, and a user interface 228. The risk and anomaly detection system 222 may be an example of a subsystem of the identity management system 220 that may be used to support the risk and anomaly detection service 180 of FIG. 1. For instance, the risk and anomaly detection system 222 may be used to train the identity LLM 226 to read and understand the system logs 227, to determine a customary pattern of behavior associated with one or more users 285 of the client system 230 based on the system log 227 data (e.g., based on a history of system events 234 associated with a particular user 285), and to predict a next expected system event or a sequence of next system events for the user 285 based on the customary pattern of behavior associated with the user 285. The risk and anomaly detection system 222 may utilize the identity LLM 226 to compare an actually-detected system event 234 associated with the user 285 with the predicted next system event. Based on detecting a difference between the actually-detected system event 234 and the predicted next system event, the identity LLM 226 may be utilized to determine a risk level associated with the detected system event. The identity LLM 226 may output the risk level associated with the detected system event to the risk and anomaly detection system 222 and, based on determining that the risk level satisfies a threshold (e.g., exceeds a threshold), the risk and anomaly detection system 222 may perform at least one remediation action. In some cases, the risk and anomaly detection system 222 may obtain policy information 229 associated with the client organization, and the policy information 229 may be configured (such as by an administrator 195 associated with the client system 230 or the identity management system 220) to indicate one or more remedial actions to be performed based on a risk level, a type of threat detected, or a combination thereof. In some cases, the administrator 195 may interact with an administrator device 210 (which may be an example of the computing device 105) to communicate with the risk and anomaly detection system 222, such as via the user interface 228 (e.g., a dashboard).

In some cases, the risk and anomaly detection system 222 may further utilize the identity LLM 226 to generate a summary of system events 234 associated with the user 285, recommendations for mitigating a risk associated with the user 285 or a detected event that poses a security threat, or a combination there of. The risk and anomaly detection system 222 may output the summary and recommendations via the user interface 228. In some implementations, the risk and anomaly detection system 222 may additionally output, at the user interface 228, a chat box for receiving natural language queries (such as from the administrator 195) related to system events 234 associated with the user 285. The risk and anomaly detection system 222 may utilize the identity LLM 226 to respond to the natural language queries using a chat bot feature of the risk and anomaly detection system 222. In some cases, the responses provided by the identity LLM 226 may include an explanation for a determination of a risk level associated with a detected system event.

### Identity LLM Training

The identity LLM 226 may be an example of a generative AI system or one or more other types of systems that support foundational models (e.g., pre-trained machine learning models). For example, the identity LLM 226 may be an example of, or may employ, a machine learning model (e.g., any machine learning model or any system that may be supported by machine learning models) trained on system log data maintained by the identity management system 220. Although the LLM 226 is illustrated in the example of FIG. 2 as being external to the risk and anomaly detection system 222, the LLM 226 may, in some implementations, be internal to the risk and anomaly detection system 222.

In some implementations, the LLM 226 may be enabled with multi-modality capability, such as being capable of performing different tasks. Accordingly, the LLM 226 may be refined to support multiple tasks, such as reading and understanding the system logs 227 associated with the identity management system 220; learning a customary pattern of behavior associated with one or more users 285 of the client system 230 based on the system log 227 data (e.g., based on a history of system events 234 associated with a particular user 285); predicting a next expected system event or a sequence of next expected system events for the user 285 based on the customary pattern of behavior associated with the user 285; determining a level of risk associated with system events or sequences of events that deviate from the predicted next expected system event or sequence of next expected system events; generating summaries related to system logs 227 and a history of system events 234; and generating explanations related to the determination of a level of risk associated with system events or sequences of events that deviate from the predicted next expected system event or sequence of next expected system events.

In some cases, refinement of the identity LLM 226 may include fine tuning, by training the model with training datasets, such as training datasets of system log 227 entries, which may cause one or more weights of the model to be updated or adjusted to improve the model's performance and accuracy with regard to predictions. In some cases, refinement of identity LLM 226 may include prompt tuning, by training the model using the training datasets without updating weights of the model. The prompt tuning may involve feeding the model front-end prompts or task-specific context that may be iteratively refined based on predictions by the model, thus resulting in more accurate predictions from the model. As such, refining the identity LLM 226 may allow for accurate predictions of a sequence of next systems events and a risk level of a deviating system event.

Accordingly, the identity LLM 226 may be trained to read and understand the system log 227. The system log 227 may be associated with the identity management system 220 and may capture a record of each of the systems events that occur in the identity management system 220 and that are associated with the client system 230. For instance, the system log 227 may record a log entry for, among other things, authentication events, access events, security events, errors, warnings, and the like. The system log 227 data may be recorded in a manner that adheres to a particular syntax, grammar, or structured format, referred to herein as “system log schema,” defined by the identity management system 220. In some cases, the system log schema may be defined in a manner that allows for it to be both machine-parsable and also human-readable. For instance, the system log 227 may include structured plain text fields or data elements that capture information such as timestamps, IP addresses, usernames, device types, device names, geographical locations, error messages, etc.

The identity LLM 226 may be trained to read and understand the system log schema of the system log 227, based on receiving training datasets that include log entries from the system log 227. Based on the training datasets, the identity LLM 226 may learn a customary pattern of behavior associated with each of the users 285 of the client system 230, for example, based on a history of system events 234 captured in the system log 227.

That is, each user 285 may have an individual pattern of behavior associated with how the user 285 engages or interacts with the client system 230 and the identity management system 220. For instance, a particular user 285 may engage in certain activities, such as logging into the client system 230 at a particular time of the day and from a particular location. The user 285 may access certain applications at certain times of the day. For example, the user 285 may typically log in on Monday through Friday at 9:00 am and first access an email application, and then typically 15 minutes later may access a scheduling application. The user 285 may log in from a client device 205 located at the user's work location. The user 285 may typically log out at 12:00 pm for lunch and then log back in at 1:00 pm and perform a sequence of customary activities. Likewise, a different user 285 may engage in certain activities that are unique to that user. Accordingly, the various activities and corresponding generated system events 234 may be captured in the system log 227 and the LLM 226 may be trained, from the system log 227 data, to learn a pattern of behavior that is particular to each user 285.

Based on learning a user's customary pattern of behavior or customary system events 234, the LLM 226 may be able to predict a next expected system event or a sequence of next expected system events for the user 285. In some cases, the predicted next system event or sequence of next system events may include an indication of an expected date or timestamp of the next expected system event, an expected IP address or geographical location associated with a request from the user 285, an expected application to be accessed, an expected type of system event, an expected duration of the expected system event, or a combination thereof of an expected system event. In some cases, one of more of the predicted elements may be based on a previous system event associated with the user 285, or based on a current date and time, a current geographical location, an application accessed, an IP address associated with a current access request, a current event type, a current event duration, or a combination thereof

By predicting such next expected system events or sequence of next expected system events for the user 285, the LLM may also be capable of identifying when a system event, or a sequence of system events, is detected that deviates from the predicted next system events or sequence of next system events. In this way, the LLM may identify deviating or anomalous system events that may be potential security risks or threats (e.g., such as an illegitimate user, security breach, a security attack, or the like) and predict a level of risk associated with such detected system events.

### System Anomaly Detection

In some implementations, to detect system anomalies, the identity LLM 226 may receive, as input, one or more entries from a system log 227 (e.g., such as a current detected system event or sequence of system events), which are associated with a user 285. Based on the input, the identity LLM 226 may output a predication as to whether the detected system event or sequence of system events deviates from a predicted next system event or sequence of next system events associated with the user 285. For example, the identity LLM 226 may compare the received detected system event or sequence of system events with the predicted next system event or sequence of next system events associated with the user 285 and, based on any detected differences or a degree of such differences, may predict whether the detected system event or sequence of system events deviate from the predicted next system event or sequence of next system events associated with the user 285 (e.g., such as deviates from customary behavior of the user 285).

In some cases, the predication may include a probability associated with whether the detected system event or sequence of events deviates from the predicted next system event or sequence of next system events associated with the user 285. In some cases, the predication may include a risk level associated with whether the detected system event or sequence of events deviates from the predicted next system event or sequence of next system events associated with the user 285. For example, the risk level may be indicated as high, medium, low, or some other gradation. When the risk level is indicated as high, medium, or low, a risk level of high may be an indication that there is high likelihood that the user 285 is not the legitimate user or that the detected system event or sequence of system events poses a significant security threat to the identity management system 220 or the client system 230. On the other hand, a risk level of low may be an indication that there is little risk that the detected system event or sequence of system events poses a security threat or an indication that the user 285 is more likely than not the legitimate user. In some examples, the risk level may be indicated as a numerical value, e.g., between 0 and 10 or 0 and 100 or some other numerical range. The risk level might not be limited to the listed examples and may, instead, include other representations or measures of risk.

In some cases, the prediction output by the identity LLM 226 may additionally include a summary of the system events associated with the user 285 that were used to generate the predication, a summary of potential concerns associated with the user 285 or the detected system event or sequence of system events, a summary of recommendations for mitigating any security risk associated with the user 285 or the detected system event or sequence of system events, or a combination thereof.

In some cases, when the risk level satisfies a threshold, the identity LLM 226 may classify the detected system event or sequence of system events as a particular type of security threat, such as a particular type of security attack or breach (e.g., a brute force attack, a phishing attack, a hijacking attack, a spraying attack, generic anomalous behavior, or the like). Accordingly, in some cases, the predication output by the identity LLM 226 may additionally include an indication of a threat type.

### Risk Remediation

The risk and anomaly detection system 222 may receive the prediction output by the identity LLM 226. The risk and anomaly detection system 222 may determine whether the risk level associated with the predication satisfies a threshold (e.g., exceeds a threshold). If the risk level satisfies the threshold, in some cases, the risk and anomaly detection system 222 may determine and perform a remedial action.

In some cases, the remedial action to be performed may be based on a policy, such as a risk policy, configured by an administrator 195 of the identity management system 220. For instance, the administrator 195 may configure a policy with certain remedial actions that should be performed when particular types of security threats are detected. Accordingly, based on a threat type indicated in the prediction generated by the identity LLM 226, the risk and anomaly detection system 222 may identify, from a plurality of policies, a policy that is configured for the predicted threat type. The risk and anomaly detection system 222 may perform or cause to be performed a remedial action associated with the determined policy. For instance, the remedial actions may include, but might not be limited to, performing a single sign-off procedure associated with the user 285, performing a quarantining procedure associated with one or more resources associated with the detected system event or sequence of system events, updating a watchlist with identification information associated with the user 285 (e.g., a username, an IP address, a device ID, etc.), sending a notification of the detected system event or sequence of events to the administrator 195, or a combination thereof.

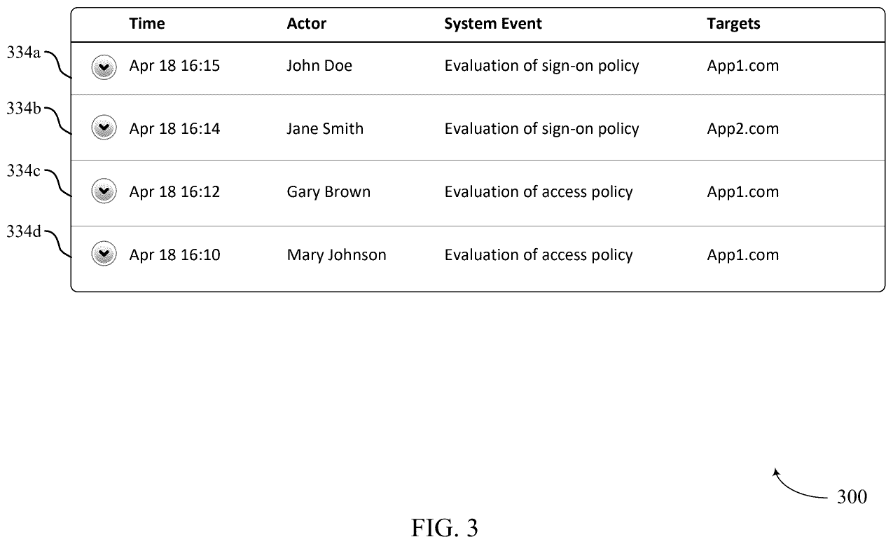

FIGS. 3 to 6 show examples of user interfaces that support risk and anomaly detection using one or more LLMs in accordance with aspects of the present disclosure. The illustrated user interfaces may be examples of user interfaces that support features of system architecture 200 of FIG. 2. For instance, the user interfaces may be examples of the user interface 228 of FIG. 2. As such, the risk and anomaly detection system 222 of FIG. 2 may generate and output one or more of the user interfaces shown in FIGS. 3 to 6. For instance, the user interfaces may be output to the administrator device 210 of FIG. 2.

Referring to FIG. 3, a user interface 300 is provided. The user interface 300 may display a listing of one or more system events 334 associated with the identity management system 220 of FIG. 2. The one or more system events 334 may be examples of the system events 234 of FIG. 2. In some cases, the system events 334 displayed in the listing may be those that occurred during a specified time period. In some cases, the listed system events 334 may be those that were identified as having a risk level that satisfies a threshold (e.g., flagged by the system as high risk). In some implementations, the administrator 195 may select one of the system events 334 to debug the selected system event 334. For instance, the administrator 195 may select system event 334a to debug the system event 334a associated with user John Doc.

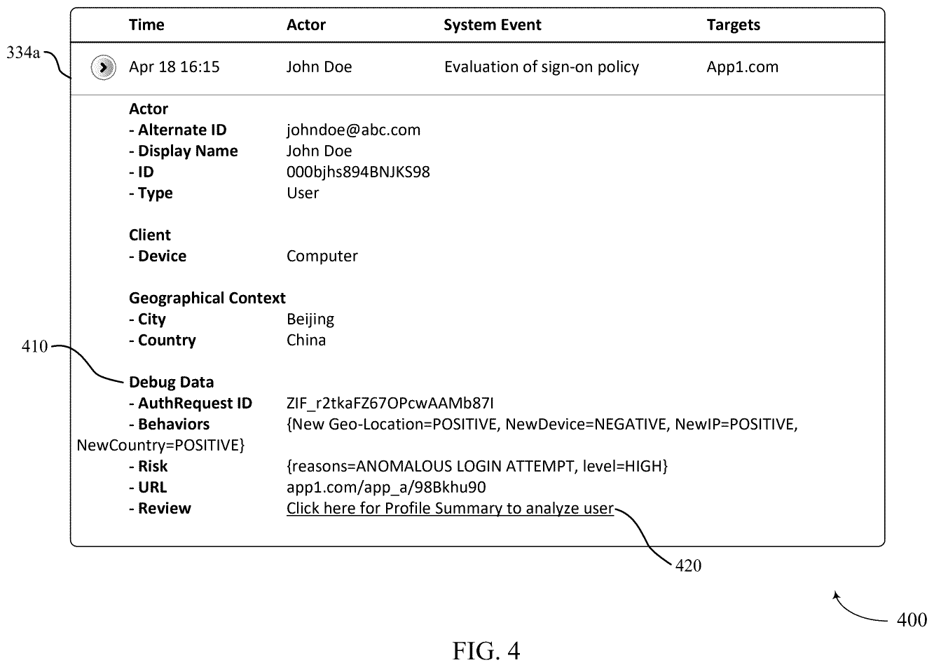

Referring to FIG. 4, a user interface 400 is provided. Based on the user selection of a system event 334a, the user interface 400 may output a portion of system log data (e.g., data from system log 227 of FIG. 2) that is associated with the selected system event 334a for the user John Doe. The user interface 400 may include debug data 410, which may be helpful to the administrator 195 in understanding detected behaviors, risk levels, and risk level reasons associated with the selected system event 334a. The user interface 400 may include a summary option 420 that may be selected for summarization information associated with the selected system event 334a (such as the summary information provided by the identity LLM 226 prediction, as described with reference to FIG. 2). For instance, the administrator 195 may wish to further investigate a system event 334 flagged as satisfying a particular threshold (such as high risk system events). As such, the administrator 195 may select the summary option 420.

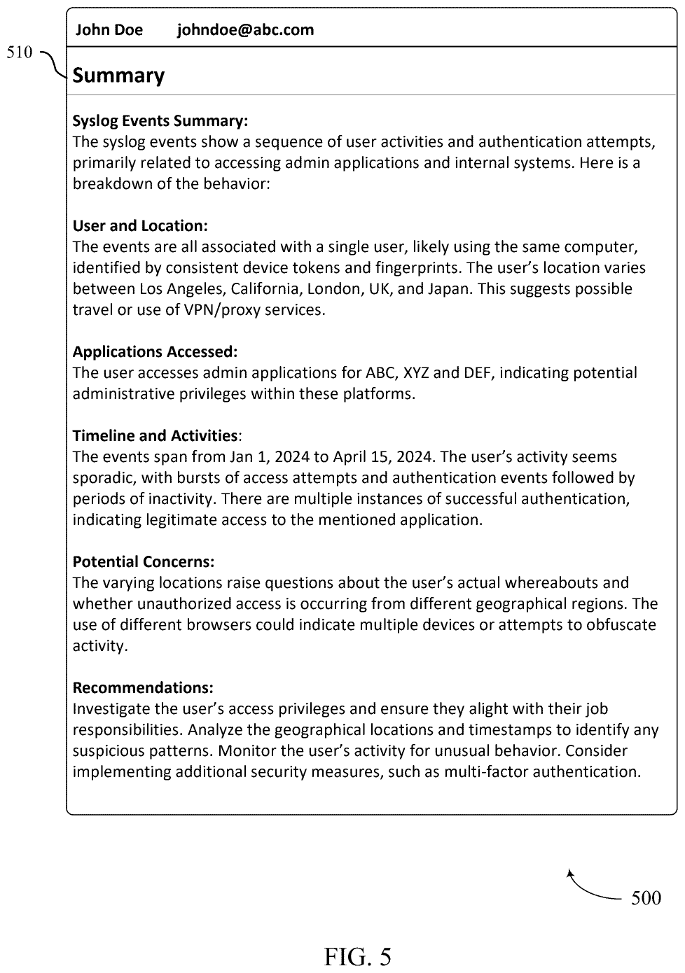

Referring to FIG. 5, a user interface 500 is provided. The user interface 500 may output a summary 510 associated with the selected system event 334a. For instance, the summary 510 may include the summary generated by the identity LLM 226 as part of its prediction. The summary 510 may include a summarization of system events associated with the user 285 of the selected system event 334a. For instance, the summarization of system events may include a summary of historical customary behavior associated with the user 285 (e.g., user identification information, identification of devices used, applications accessed, geographical locations, activity times, types of events or activities, periods of inactivity, and the like), a summary of a potential risk associated with the user 285 or with the selected system event 334, a summary of recommendations for remediating a risk associated with the user 285 or with the selected system event 334, or a combination thereof.

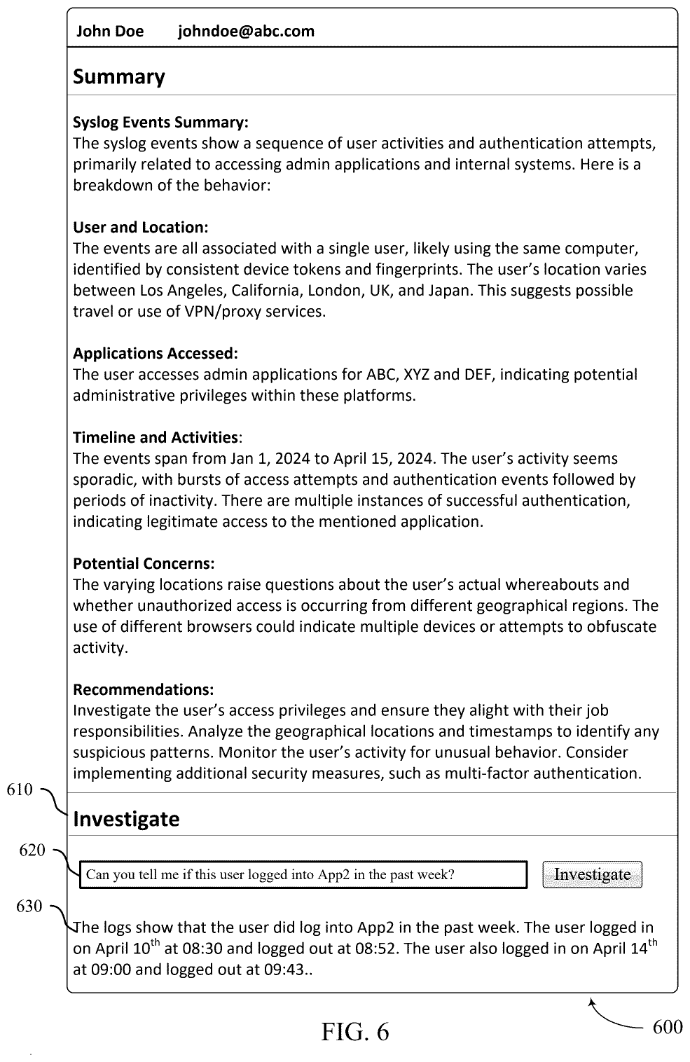

Referring to FIG. 6, a user interface 600 is provided. The user interface 600 may output an investigate feature 610. In some instances, the administrator 195 may require a further detailed explanation, may want to further investigate a potential security issue associated with the selected system event 334a, or may want to perform additional remedial actions associated with the selected system event 334a. Accordingly, a chat box 620 may be provided through which the administrator 195 may converse with a chat bot associated with the identity LLM 226 about one or more of the system events 334 or about conditions of the identity management system 220 more broadly. For instance, the administrator 195 may pose natural language queries to the chat bot and the LLM 226 generate responses to the queries which may be output to the user interface 600.

For instance, the administrator 195 may enter a query into the chat box 620 such as: “Why is this system event being flagged as suspicious?” “What is the normal behavior for this user?” “What applications has the user accessed over the past 3 months?” “What other activities are happening at this IP address for other users?” or other questions related to the selected system event 334a (or, in some cases, other system events 334). The chat bot may utilize the identity LLM 226 to generate responses 630 to the queries, which may be output, such as by the risk and anomaly detection system 222, to the user interface 600. For instance, the LLM 226 may generate explanations as to the reason a particular system event 334 was predicted to have an indicated risk level, of the differences that exist between the selected system event 334a and a predicted next system event or sequence of next sequence events, as to the reason a particular remedial action was taken, or other questions.

In some cases, the administrator 195 may provide feedback associated with the prediction made by the identity LLM 226 for the selected system event 334a. For instance, in some cases, the administrator 195 may indicate through the chat box 620 that she is in agreement with the prediction. In some cases, the administrator 195 may indicate through the chat box 620 that the prediction was a false positive and may request that the risk level be reduced and the risk level may be reduced. In some cases, the administrator 195 may indicate through the chat box 620 that the risk level should be increased and the risk level may be increased. In some cases, the administrator 195 may indicate that an additional remedial action should be taken and the additional remedial action may be performed. In some cases, the administrator 195 may provide different feedback. The feedback provided by the administrator 195 may be fed back to the identity LLM 226 to update the identity LLM 226 (e.g., one or more weights or parameters) to improve future predictions.

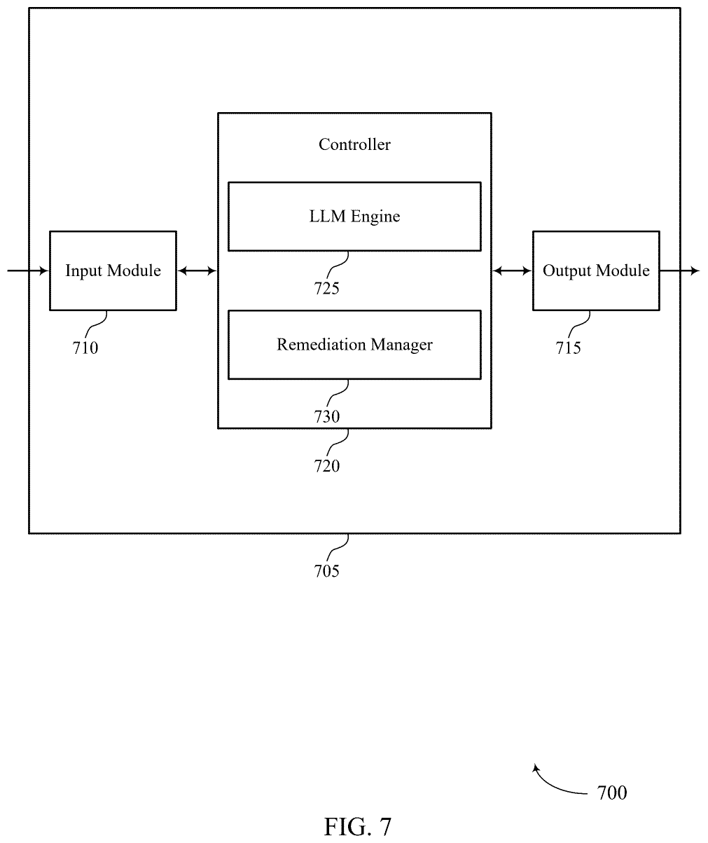

FIG. 7 shows a block diagram 700 of a device 705 that supports risk and anomaly detection using one or more LLMs in accordance with aspects of the present disclosure. The device 705 may include an input module 710, an output module 715, and a controller 720. The device 705, or one of more components of the device 705 (e.g., the input module 710, the output module 715, the controller 720), may include at least one processor, which may be coupled with at least one memory, to support the described techniques. Each of these components may be in communication with one another (e.g., via one or more buses).

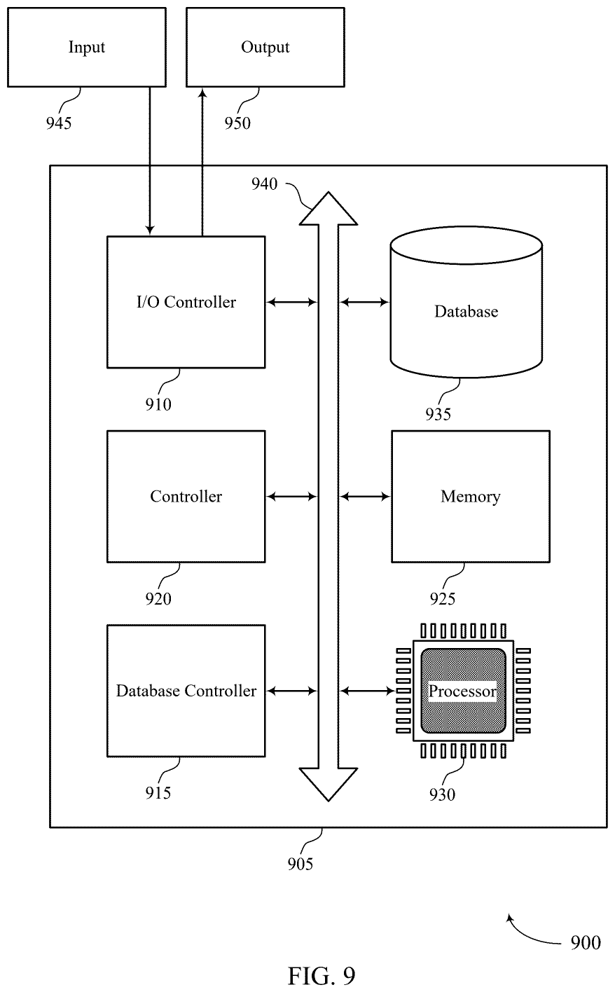

The input module 710 may manage input signals for the device 705. For example, the input module 710 may identify input signals based on an interaction with a modem, a keyboard, a mouse, a touchscreen, or a similar device. These input signals may be associated with user input or processing at other components or devices. In some cases, the input module 710 may utilize an operating system such as iOS®, ANDROID®, MS-DOS®, MS-WINDOWS®, OS/2®, UNIX®, LINUX®, or another known operating system to handle input signals. The input module 710 may send aspects of these input signals to other components of the device 705 for processing. For example, the input module 710 may transmit input signals to the controller 720 to support risk and anomaly detection using one or more LLMs. In some cases, the input module 710 may be a component of an input/output (I/O) controller 910 as described with reference to FIG. 9.

The output module 715 may manage output signals for the device 705. For example, the output module 715 may receive signals from other components of the device 705, such as the controller 720, and may transmit these signals to other components or devices. In some examples, the output module 715 may transmit output signals for display in a user interface, for storage in a database or data store, for further processing at a server or server cluster, or for any other processes at any number of devices or systems. In some cases, the output module 715 may be a component of an I/O controller 910 as described with reference to FIG. 9.

For example, the controller 720 may include an LLM engine 725 a remediation manager 730, or any combination thereof. In some examples, the controller 720, or various components thereof, may be configured to perform various operations (e.g., receiving, monitoring, transmitting) using or otherwise in cooperation with the input module 710, the output module 715, or both. For example, the controller 720 may receive information from the input module 710, send information to the output module 715, or be integrated in combination with the input module 710, the output module 715, or both to receive information, transmit information, or perform various other operations as described herein.

The LLM engine 725 may be configured to support generating, using a large language model (LLM), a sequence of predicted next system events associated with a user of the identity management system. The LLM engine 725 may be configured to support comparing, using the LLM, a detected system event associated with the user to a predicted next system event of the sequence of predicted next system events. The LLM engine 725 may be configured to support determining, using the LLM and based on a difference between the detected system event and the predicted next system event, a risk level associated with the detected system event. The remediation manager 730 may be configured to support performing, based on policy information associated with the identity management system and on a determination that the risk level satisfies a threat threshold, a remediation action.

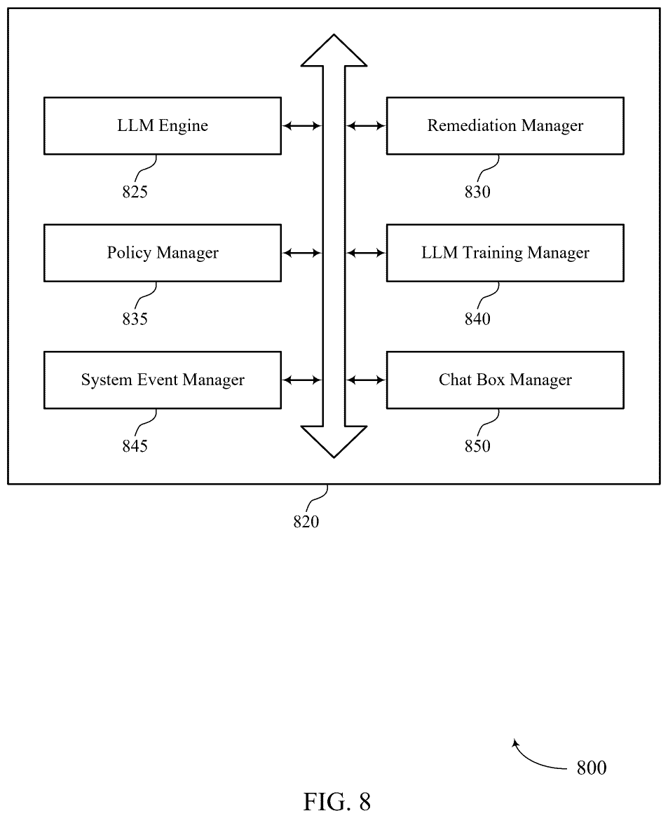

FIG. 8 shows a block diagram 800 of a controller 820 that supports risk and anomaly detection using one or more LLMs in accordance with aspects of the present disclosure. The controller 820 may be an example of aspects of a controller or a controller 720, or both, as described herein. The controller 820, or various components thereof, may be an example of means for performing various aspects of risk and anomaly detection using one or more LLMs as described herein. For example, the controller 820 may include an LLM engine 825, a remediation manager 830, a policy manager 835, an LLM training manager 840, a system event manager 845, a chat box manager 850, or any combination thereof. Each of these components, or components of subcomponents thereof (e.g., one or more processors, one or more memories), may communicate, directly or indirectly, with one another (e.g., via one or more buses).

The LLM engine 825 may be configured to support generating, using a large language model (LLM), a sequence of predicted next system events associated with a user of the identity management system. In some examples, the LLM engine 825 may be configured to support comparing, using the LLM, a detected system event associated with the user to a predicted next system event of the sequence of predicted next system events. In some examples, the LLM engine 825 may be configured to support determining, using the LLM and based on a difference between the detected system event and the predicted next system event, a risk level associated with the detected system event. The remediation manager 830 may be configured to support performing, based on policy information associated with the identity management system and on a determination that the risk level satisfies a threat threshold, a remediation action.

In some examples, the LLM engine 825 may be configured to support classifying, using the LLM and based on the determination that the risk level satisfies the threat threshold, the detected system event as a first threat type of a set of multiple threat types. In some examples, the policy manager 835 may be configured to support determining a first policy configured for the first threat type. In some examples, the policy manager 835 may be configured to support determining, based on the first policy, the policy information.

In some examples, the LLM training manager 840 may be configured to support training, using one or more system logs associated with the identity management system, the LLM to learn a sequence of system events associated with each user of a set of multiple users of the identity management system.

In some examples, the sequence of system events associated with each user is based on a history of customary behaviors or activities associated with the user and identified in the one or more system logs.

In some examples, the predicted next system event includes an indication of a date, a timestamp, a geographical location, an application, an IP address, an event type, an event duration, or a combination thereof of an expected system event.

In some examples, the predicted next system event is based on a previous user event, a current date, a current time, a current geographical location, an application accessed, an IP address associated with a current access request, a current event type, a current event duration, or a combination thereof.

In some examples, to support performing the remediation action, the remediation manager 830 may be configured to support performing a single sign-off procedure associated with the user. In some examples, to support performing the remediation action, the remediation manager 830 may be configured to support performing a quarantining procedure associated with one or more resources associated with the detected system event. In some examples, to support performing the remediation action, the remediation manager 830 may be configured to support updating a watchlist with identification information associated with the user. In some examples, to support performing the remediation action, the remediation manager 830 may be configured to support sending, to an administrator associated with the identity management system, a notification of the detected system event associated with the user. In some examples, to support performing the remediation action, the remediation manager 830 may be configured to support a combination thereof.

In some examples, the system event manager 845 may be configured to support outputting, to a user interface associated with the identity management system and based on a determination that the risk level satisfies the threat threshold, a listing of one or more system events associated with the identity management system. In some examples, the system event manager 845 may be configured to support receiving, via the user interface, a user selection to debug a first system event of the one or more system events.

In some examples, the first system event includes the detected system event, and the LLM engine 825 may be configured to support generating, based on the user selection to debug the detected system event and using the LLM, a summary of system events associated with the user, where the summary of system events associated with the user includes a summary of historical customary behavior associated with the user, a summary of a potential risk associated with the user, a summary of recommendations for remediating a risk associated with the user, or a combination thereof.

In some examples, the summary of historical customary behavior associated with the user includes a summary of customary system events, user activities, devices used, applications accessed, geographical locations, activity times, types of events or activities, periods of inactivity, or a combination thereof.

In some examples, the first system event includes the detected system event, and the chat box manager 850 may be configured to support receiving, at a chat box output at the user interface, a user query associated with the detected system event. In some examples, the first system event includes the detected system event, and the LLM engine 825 may be configured to support outputting, to the user interface and using the LLM, a response to the user query, where the response includes an explanation of a reason for the determination of the risk level associated with the detected system event.

In some examples, the first system event includes the detected system event, and the chat box manager 850 may be configured to support receiving, at a chat box output at the user interface, a user request to perform a second remediation action associated with the detected system event, where the second remediation action is different from the remediation action. In some examples, the first system event includes the detected system event, and the remediation manager 830 may be configured to support performing the second remediation action. In some examples, the first system event includes the detected system event, and the LLM training manager 840 may be configured to support updating, based on feedback indicating the second remediation action, the LLM.

FIG. 9 shows a diagram of a system 900 including a device 905 that supports risk and anomaly detection using one or more LLMs in accordance with aspects of the present disclosure. The device 905 may be an example of or include components of a device 705 as described herein. The device 905 may include components for bi-directional voice and data communications including components for transmitting and receiving communications, such as a controller 920, an I/O controller, such as an I/O controller 910, a database controller 915, at least one memory 925, at least one processor 930, and a database 935. These components may be in electronic communication or otherwise coupled (e.g., operatively, communicatively, functionally, electronically, electrically) via one or more buses (e.g., a bus 940).

The I/O controller 910 may manage input signals 945 and output signals 950 for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOS®, MS-WINDOWS®, OS/2®, UNIX®, LINUX®, or another known operating system. In other cases, the I/O controller 910 may represent or interact with a modem, a keyboard, a mouse, a touchscreen, or a similar device. In some cases, the I/O controller 910 may be implemented as part of a processor 930. In some examples, a user may interact with the device 905 via the I/O controller 910 or via hardware components controlled by the I/O controller 910.

The database controller 915 may manage data storage and processing in a database 935. In some cases, a user may interact with the database controller 915. In other cases, the database controller 915 may operate automatically without user interaction. The database 935 may be an example of a single database, a distributed database, multiple distributed databases, a data store, a data lake, or an emergency backup database.

Memory 925 may include random-access memory (RAM) and read-only memory (ROM). The memory 925 may store computer-readable, computer-executable software including instructions that, when executed, cause at least one processor 930 to perform various functions described herein. In some cases, the memory 925 may contain, among other things, a basic I/O system (BIOS) which may control basic hardware or software operation such as the interaction with peripheral components or devices. The memory 925 may be an example of a single memory or multiple memories. For example, the device 905 may include one or more memories 925.

The processor 930 may include an intelligent hardware device (e.g., a general-purpose processor, a digital signal processor (DSP), a central processing unit (CPU), a microcontroller, an application-specific integrated circuit (ASIC), a field-programmable gate array (FPGA), a programmable logic device, a discrete gate or transistor logic component, a discrete hardware component, or any combination thereof). In some cases, the processor 930 may be configured to operate a memory array using a memory controller. In other cases, a memory controller may be integrated into the processor 930. The processor 930 may be configured to execute computer-readable instructions stored in at least one memory 925 to perform various functions (e.g., functions or tasks supporting risk and anomaly detection using one or more LLMs). The processor 930 may be an example of a single processor or multiple processors. For example, the device 905 may include one or more processors 930.

For example, the controller 920 may be configured to support generating, using a large language model (LLM), a sequence of predicted next system events associated with a user of the identity management system. The controller 920 may be configured to support comparing, using the LLM, a detected system event associated with the user to a predicted next system event of the sequence of predicted next system events. The controller 920 may be configured to support determining, using the LLM and based on a difference between the detected system event and the predicted next system event, a risk level associated with the detected system event. The controller 920 may be configured to support performing, based on policy information associated with the identity management system and on a determination that the risk level satisfies a threat threshold, a remediation action.

By including or configuring the controller 920 in accordance with examples as described herein, the device 905 may support techniques for improved system security, improved user experience related to identifying security threats and risk, and improved means for automatic system remediation of security threats.

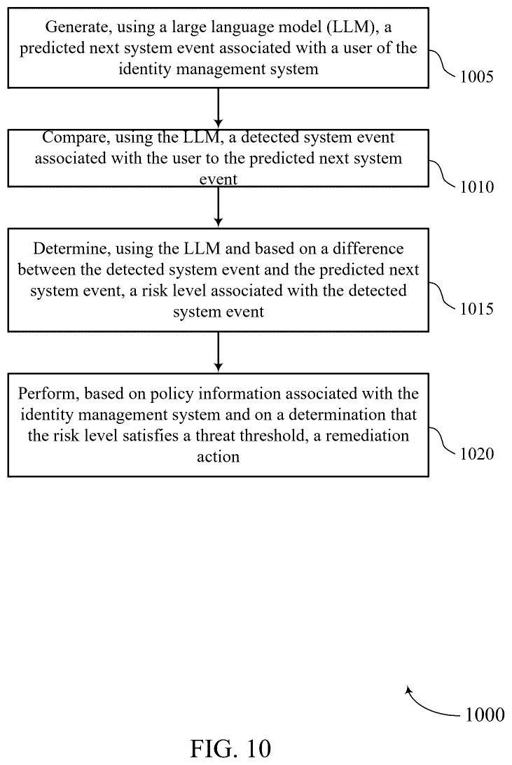

FIG. 10 shows a flowchart illustrating a method 1000 that supports risk and anomaly detection using one or more LLMs, in accordance with aspects of the present disclosure. The operations of the method 1000 may be implemented by an identity management system or its components as described herein. For example, the operations of the method 1000 may be performed by an identity management system as described with reference to FIGS. 1 through 9. In some examples, an identity management system may execute a set of instructions to control the functional elements of the identity management system to perform the described functions. Additionally, or alternatively, the identity management system may perform aspects of the described functions using special-purpose hardware.

At 1005, the method may include generating, using an LLM, a sequence of predicted next system events associated with a user of the identity management system. The operations of 1005 may be performed in accordance with examples as disclosed herein. In some examples, aspects of the operations of 1005 may be performed by an LLM engine 825 as described with reference to FIG. 8.

At 1010, the method may include comparing, using the LLM, a detected system event associated with the user to a predicted next system event of the sequence of predicted next system events. The operations of 1010 may be performed in accordance with examples as disclosed herein. In some examples, aspects of the operations of 1010 may be performed by an LLM engine 825 as described with reference to FIG. 8.

At 1015, the method may include determining, using the LLM and based on a difference between the detected system event and the predicted next system event, a risk level associated with the detected system event. The operations of 1015 may be performed in accordance with examples as disclosed herein. In some examples, aspects of the operations of 1015 may be performed by an LLM engine 825 as described with reference to FIG. 8.

At 1020, the method may include performing, based on policy information associated with the identity management system and on a determination that the risk level satisfies a threat threshold, a remediation action. The operations of 1020 may be performed in accordance with examples as disclosed herein. In some examples, aspects of the operations of 1020 may be performed by a Remediation manager 830 as described with reference to FIG. 8.

The following provides an overview of aspects of the present disclosure:

Aspect 1: A method of an identity management system, comprising: generating, using an LLM, a sequence of predicted next system events associated with a user of the identity management system; comparing, using the LLM, a detected system event associated with the user to a predicted next system event of the sequence of predicted next system events; determining, using the LLM and based at least in part on a difference between the detected system event and the predicted next system event, a risk level associated with the detected system event; and performing, based at least in part on policy information associated with the identity management system and on a determination that the risk level satisfies a threat threshold, a remediation action.

Aspect 2: The method of aspect 1, further comprising: classifying, using the LLM and based at least in part on the determination that the risk level satisfies the threat threshold, the detected system event as a first threat type of a plurality of threat types; determining a first policy configured for the first threat type; and determining, based at least in part on the first policy, the policy information.

Aspect 3: The method of any of aspects 1 through 2, further comprising: training, using one or more system logs associated with the identity management system, the LLM to learn a sequence of system events associated with each user of a plurality of users of the identity management system.

Aspect 4: The method of aspect 3, wherein the sequence of system events associated with each user is based at least in part on a history of customary behaviors or activities associated with the user and identified in the one or more system logs.

Aspect 5: The method of any of aspects 1 through 4, wherein the predicted next system event comprises an indication of a date, a timestamp, a geographical location, an application, an IP address, an event type, an event duration, or a combination thereof of an expected system event.

Aspect 6: The method of any of aspects 1 through 5, wherein the predicted next system event is based at least in part on a previous user event, a current date, a current time, a current geographical location, an application accessed, an IP address associated with a current access request, a current event type, a current event duration, or a combination thereof.

Aspect 7: The method of any of aspects 1 through 6, wherein performing the remediation action comprises: performing a single sign-off procedure associated with the user; performing a quarantining procedure associated with one or more resources associated with the detected system event; updating a watchlist with identification information associated with the user; sending, to an administrator associated with the identity management system, a notification of the detected system event associated with the user; or a combination thereof.

Aspect 8: The method of any of aspects 1 through 7, further comprising: outputting, to a user interface associated with the identity management system and based at least in part on a determination that the risk level satisfies the threat threshold, a listing of one or more system events associated with the identity management system; and receiving, via the user interface, a user selection to debug a first system event of the one or more system events.

Aspect 9: The method of aspect 8, wherein the first system event comprises the detected system event, and wherein the method further comprises: generating, based at least in part on the user selection to debug the detected system event and using the LLM, a summary of system events associated with the user, wherein the summary of system events associated with the user comprises a summary of historical customary behavior associated with the user, a summary of a potential risk associated with the user, a summary of recommendations for remediating a risk associated with the user, or a combination thereof.

Aspect 10: The method of aspect 9, wherein the summary of historical customary behavior associated with the user comprises a summary of customary system events, user activities, devices used, applications accessed, geographical locations, activity times, types of events or activities, periods of inactivity, or a combination thereof.

Aspect 11: The method of any of aspects 8 through 10, wherein the first system event comprises the detected system event, and wherein the method further comprises: receiving, at a chat box output at the user interface, a user query associated with the detected system event; and outputting, to the user interface and using the LLM, a response to the user query, wherein the response includes an explanation of a reason for the determination of the risk level associated with the detected system event.

Aspect 12: The method of any of aspects 8 through 11, wherein the first system event comprises the detected system event, and wherein the method further comprises: receiving, at a chat box output at the user interface, a user request to perform a second remediation action associated with the detected system event, wherein the second remediation action is different from the remediation action; performing the second remediation action; and updating, based at least in part on feedback indicating the second remediation action, the LLM.

Aspect 13: An apparatus comprising one or more memories storing processor-executable code, and one or more processors coupled with the one or more memories and individually or collectively operable to execute the code to cause the apparatus to perform a method of any of aspects 1 through 12.

Aspect 14: An apparatus comprising at least one means for performing a method of any of aspects 1 through 12.

Aspect 15: A non-transitory computer-readable medium storing code the code comprising instructions executable by one or more processors to perform a method of any of aspects 1 through 12.

It should be noted that the methods described above describe possible implementations, and that the operations and the steps may be rearranged or otherwise modified and that other implementations are possible. Furthermore, aspects from two or more of the methods may be combined.

The description set forth herein, in connection with the appended drawings, describes example configurations, and does not represent all the examples that may be implemented, or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by one or more processors, firmware, or any combination thereof. If implemented in software executed by one or more processors, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations.

Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable ROM (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor.

Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A method of an identity management system, comprising:
generating, using a large language model (LLM), a predicted sequence of next system events associated with a user of the identity management system;
comparing, using the LLM, a detected system event associated with the user to a predicted next system event of the predicted sequence of next system events;
determining, using the LLM and based at least in part on a difference between the detected system event and the predicted next system event, a risk level associated with the detected system event; and
performing, based at least in part on policy information associated with the identity management system and on a determination that the risk level satisfies a threat threshold, a remediation action.

2. The method of claim 1, further comprising:
classifying, using the LLM and based at least in part on the determination that the risk level satisfies the threat threshold, the detected system event as a first threat type of a plurality of threat types;
determining a first policy configured for the first threat type; and
determining, based at least in part on the first policy, the policy information.

3. The method of claim 1, further comprising:
training, using one or more system logs associated with the identity management system, the LLM to learn a sequence of system events associated with each user of a plurality of users of the identity management system.

4. The method of claim 3, wherein the sequence of system events associated with each user is based at least in part on a history of customary behaviors or activities associated with the user and identified in the one or more system logs.

5. The method of claim 1, wherein the predicted next system event comprises an indication of a date, a timestamp, a geographical location, an application, an IP address, an event type, an event duration, or a combination thereof of an expected system event.

6. The method of claim 1, wherein the predicted next system event is based at least in part on a previous user event, a current date, a current time, a current geographical location, an application accessed, an IP address associated a current access request, a current event type, a current event duration, or a combination thereof.

7. The method of claim 1, wherein performing the remediation action comprises:
performing a single sign-off procedure associated with the user;
performing a quarantining procedure associated with one or more resources associated with the detected system event;
updating a watchlist with identification information associated with the user;
sending, to an administrator associated with the identity management system, a notification of the detected system event associated with the user; or
a combination thereof.

8. The method of claim 1, further comprising:
outputting, to a user interface associated with the identity management system and based at least in part on a determination that the risk level satisfies the threat threshold, a listing of one or more system events associated with the identity management system; and
receiving, via the user interface, a user selection to debug a first system event of the one or more system events.

9. The method of claim 8, wherein the first system event comprises the detected system event, and wherein the method further comprises:
generating, based at least in part on the user selection to debug the detected system event and using the LLM, a summary of system events associated with the user, wherein the summary of system events associated with the user comprises a summary of historical customary behavior associated with the user, a summary of a potential risk associated with the user, a summary of recommendations for remediating a risk associated with the user, or a combination thereof.

10. The method of claim 9, wherein the summary of historical customary behavior associated with the user comprises a summary of customary system events, user activities, devices used, applications accessed, geographical locations, activity times, types of events or activities, periods of inactivity, or a combination thereof.

11. The method of claim 8, wherein the first system event comprises the detected system event, and wherein the method further comprises:
receiving, at a chat box output at the user interface, a user query associated with the detected system event; and
outputting, to the user interface and using the LLM, a response to the user query, wherein the response includes an explanation of a reason for the determination of the risk level associated with the detected system event.

12. The method of claim 8, wherein the first system event comprises the detected system event, and wherein the method further comprises:
receiving, at a chat box output at the user interface, a user request to perform a second remediation action associated with the detected system event, wherein the second remediation action is different from the remediation action;
performing the second remediation action; and
updating, based at least in part on feedback indicating the second remediation action, the LLM.

13. An identity management system, comprising:
one or more memories storing processor-executable code; and
one or more processors coupled with the one or more memories and individually or collectively operable to execute the code to cause the identity management system to:
generate, using a large language model (LLM), a predicted sequence of next system events associated with a user of the identity management system;
compare, using the LLM, a detected system event associated with a predicted next system event of the predicted sequence of next system events;
determine, using the LLM and based at least in part on a difference between the detected system event and the predicted next system event, a risk level associated with the detected system event; and
perform, based at least in part on policy information associated with the identity management system and on a determination that the risk level satisfies a threat threshold, a remediation action.

14. The identity management system of claim 13, wherein the one or more processors are individually or collectively further operable to execute the code to cause the identity management system to:
classify, using the LLM and based at least in part on the determination that the risk level satisfies the threat threshold, the detected system event as a first threat type of a plurality of threat types;
determine a first policy configured for the first threat type; and
determine, based at least in part on the first policy, the policy information.

15. The identity management system of claim 13, wherein the one or more processors are individually or collectively further operable to execute the code to cause the identity management system to:
training, used one or more system logs associated with the identity management system, the LLM to learn a sequence of system events associated with each user of a plurality of users of the identity management system.

16. The identity management system of claim 15, wherein the sequence of system events associated with each user is based at least in part on a history of customary behaviors or activities associated with the user and identified in the one or more system logs.

17. The identity management system of claim 13, wherein the predicted next system event comprises an indication of a date, a timestamp, a geographical location, an application, an IP address, an event type, an event duration, or a combination thereof of an expected system event.

18. The identity management system of claim 13, wherein the predicted next system event is based at least in part on a previous user event, a current date, a current time, a current geographical location, an application accessed, an IP address associated a current access request, a current event type, a current event duration, or a combination thereof.

19. The identity management system of claim 13, wherein the one or more processors are individually or collectively further operable to execute the code to cause the identity management system to:
output, to a user interface associated with the identity management system and based at least in part on a determination that the risk level satisfies the threat threshold, a listing of one or more system events associated with the identity management system;
receive, via the user interface, a user selection to debug a first system event of the one or more system events, wherein the first system event comprises the detected system event; and
generate, based at least in part on the user selection to debug the detected system event and using the LLM, a summary of system events associated with the user, wherein the summary of system events associated with the user comprises a summary of historical customary behavior associated with the user, a summary of a potential risk associated with the user, a summary of recommendations for remediating a risk associated with the user, or a combination thereof, wherein the summary of historical customary behavior associated with the user comprises a summary of customary system events, user activities, devices used, applications accessed, geographical locations, activity times, types of events or activities, periods of inactivity, or a combination thereof.

20. A non-transitory computer-readable medium storing code, the code comprising instructions executable by one or more processors of an identity management system to:
generate, using a large language model (LLM), a predicted sequence of next system events associated with a user of the identity management system;
compare, using the LLM, a detected system event associated with the user to a predicted next system event of the predicted sequence of next system events;
determine, using the LLM and based at least in part on a difference between the detected system event and the predicted next system event, a risk level associated with the detected system event; and
perform, based at least in part on policy information associated with the identity management system and on a determination that the risk level satisfies a threat threshold, a remediation action.
